(19) United States
(12) Patent Application Publication
(10) Pub. No.: US 2024/0347858 A1
(43) Pub. Date: Oct. 17, 2024

(54) METHODS FOR PREPARING POROUS SEPARATORS FOR ELECTROCHEMICAL CELLS

(71) Applicant: University of Rochester, Rochester, NY (US)

(72) Inventors: Wyatt E. TENHAEFF, Pittsford, NY (US); Alexander J. MANLY, Williamsville, NY (US)

(21) Appl. No.: 18/682,882

(22) PCT Filed: Sep. 6, 2022
(86) PCT No.: PCT/US2022/042663

§ 371 Date: Feb. 9, 2024

Related U.S. Application Data
(60) Provisional application No. 63/241,447, filed on Sep. 7, 2021.

(51) Int. Cl. H01M 50/42; H01M 10/0525; H01M 50/403; H01M 50/491

(52) U.S. Cl. CPC H01M 50/42; H01M 50/403; H01M 50/491; H01M 10/0525

(57) ABSTRACT

Embodiments of the present disclosure generally relate to methods for preparing porous separators used in battery technology, such as within an electrochemical cell. In one or more embodiments, a method of preparing a porous separator for an electrochemical cell is provided and includes placing a mixture containing a polymer precursor composition and a porogen onto a surface and forming a polymeric film on the surface from the mixture by a polymerization process. The polymeric film contains pores distributed throughout a polymeric material. The pores are formed during the polymerization process and the porogen is disposed within the pores. In one or more examples, the polymeric film is formed by a polymerization-induced phase separation (PIPS) process and contains about 20 wt % to about 70 wt % of the porogen.

### CROSS-REFERENCE TO RELATED APPLICATIONS

This application claims benefit to U.S. Prov. Appl. No. 63/241,447, filed on Sep. 7, 2021, which is herein incorporated by reference.

### STATEMENT REGARDING FEDERALLY SPONSORED RESEARCH OR DEVELOPMENT

This invention was made with government support under Contract No. CBET-1845805 awarded by the National Science Foundation. The government has certain rights in the invention.

### BACKGROUND

### Field

Embodiments of the present disclosure generally relate to battery technology, and more specifically, to methods for preparing porous separators used in electrochemical cells.

### Description of the Related Art

Lithium ion batteries (LIBs), and other types of batteries, can have one or multiple electrochemical cells for generating electrical power. Each electrochemical cell typically has a separator positioned between a cathode and an anode. The separator keeps the cathode and the anode separated so to reduce or eliminate short circuiting between the electrodes. In addition, the separator allows ions (e.g., Li⁺ in a lithium ion cell) to pass between the cathode and the anode. High energy density and larger capacity cell requirements are becoming increasingly more stringent, which drives the need for more efficient separators.

The current industry standard separators typically involve relatively complicated manufacturing processes which require the separator to be prepared outside of the battery or electrochemical cell. Such separators usually contain polyolefin plastics, which are produced from gases such as ethylene and/or propene. The production process used to prepare polyolefin plastic requires specialized and expensive catalysts and equipment. After being prepared, the polyolefin or other plastic must be extruded into sheets and finally mechanically stressed to form pores. Due to the relative chemical inertness of polyolefins and their limited solubility in common processing solvents, the pore formation step is relatively complex and adds significant cost to the material. The porous separators are then applied to a battery electrode in a roll-to-roll process.

Therefore, there is a need for improved methods for preparing porous separators used in electrochemical cells.

### SUMMARY

Embodiments of the present disclosure generally relate to methods for preparing porous separators used in battery technology, such as within an electrochemical cell. In one or more embodiments, a method of preparing a porous separator for an electrochemical cell is provided and includes placing a mixture containing a polymer precursor composition and a porogen onto a surface and forming a polymeric film on the surface from the mixture by a polymerization process. The polymeric film contains pores distributed throughout a polymeric material. The pores are formed during the polymerization process and the porogen is disposed within the pores. In a subsequent process, the porogen is removed to reveal the pores.

In some embodiments, a method of preparing a porous separator includes placing a mixture containing a polymer precursor composition and a porogen containing ethylene carbonate onto a surface and forming a polymeric film on the surface from the mixture by a polymerization-induced phase separation (PIPS) process. The polymeric film contains pores formed during the PIPS process. The porogen is disposed within the pores distributed throughout the polymeric film. The polymeric film contains about 20 wt % to about 70 wt % of the porogen.

In other embodiments, a porous separator for an electrochemical cell is provided and includes a polymeric film containing pores distributed throughout a polymeric material, where the polymeric film has a porosity of about 10% to about 50% and a thickness of about 1 μm to about 200 μm. The porous separator also includes a porogen disposed within the pores, where the porogen contains ethylene carbonate (EC), dimethyl carbonate (DMC), propylene carbonate (PC), vinylene carbonate, diethyl carbonate, fluoroethylene carbonate (FEC), derivatives thereof, or any combination thereof.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, may admit to other equally effective embodiments.

FIG. 1 depicts a cross-sectional view of an electrochemical cell containing a porous separator, as described and discussed in one or more embodiments herein.

FIGS. 2A-2D are scanning electron microscope (SEM) images of porous separators having varying porosity, as described and discussed in one or more embodiments herein.

To facilitate understanding, identical reference numerals have been used, where possible, to designate identical elements that are common to the Figures. It is contemplated that elements and features of one or more embodiments may be beneficially incorporated in other embodiments.

### DETAILED DESCRIPTION

Embodiments of the present disclosure generally relate to methods for preparing porous separators used in battery technology, such as within an electrochemical cell. In one or more embodiments, a method of preparing a porous separator includes forming a polymeric film from a mixture containing a polymer precursor composition and a porogen by a polymerization process. The porogen assists in the formation of pores during the polymerization process. The polymeric film contains a polymeric material having a plurality of pores distributed throughout. The porogen is disposed within the pores. The porosity of the polymeric film can be controlled by varying the composition and amount of porogen used in the polymerization process.

It has been surprisingly and unexpectedly discovered that by following the methods discussed and described herein, porous separators with exceptional performance properties can be prepared and utilized in battery environments, such as within electrochemical cells. The methods surprisingly and unexpectedly provide enhanced porosity and electrolyte uptake by the porous separators which have a relatively minimal thickness and long life expectancy in a battery environment.

In one or more embodiments, a method of preparing a porous separator for an electrochemical cell is provided and includes placing a mixture containing a polymer precursor composition and a porogen onto a surface. The surface can be one or more surfaces within a reaction cell, such as between plates or slides separated by one or more spacers. In other embodiments, the surface can be one or more surfaces of an electrode (e.g., cathode or anode) within an electrochemical cell or battery. A polymerization process is performed to produce a polymeric film on the surface from the mixture containing the polymer precursor composition and the porogen.

In other embodiments, a method of preparing a separator for an electrochemical cell is provided and includes placing a mixture containing a polymer precursor composition and a porogen onto a surface and forming a polymeric film on the surface from the mixture by a polymerization process. The porogen is disposed throughout the polymeric film. In one or more examples, the method further includes removing the porogen from the polymeric film to produce and/or reveal pores throughout the polymeric film.

The polymerization process can be one of a variety of different types and can be initiated by ultraviolet (UV) radiation, visible light, electron beam, heat, and/or other energy sources. The polymerization process can be one of a variety of radical polymerizations processes. In some examples, the polymerization process can be a photopolymerization process and include the use of epoxides with cationic photo-initiators and thio-lene reactions. In other examples, the polymerization process can include the use of acrylates and/or methacrylates. In some examples, the polymerization process can be a thermosetting process utilizing epoxy or urethane with a prepolymer, such as an epoxy resin. Exemplary polymerization processes can be or include a polymerization-induced phase separation (PIPS) process, a polymerization-induced microphase separation (PIMS) process, a photo-induced phase separation process, or a reaction-induced phase separation process. In one or more examples, the pores are formed at same time as the polymeric material is produced through the polymerization process (e.g., PIPS process). As polymerization processes proceeds, the porogen becomes immiscible in polymer matrix and separates into a second phase. At this point, the porogen constitutes the second phase. In other examples, the polymeric material contains the porogen embedded therein and the pores are produced and/or revealed upon removal of at least some, if not all, of the porogen.

Depending on the type of polymerization process used to produce the polymeric film, various temperatures can be used to control the pore size. During spinodal decomposition, fluctuations occur that cause local separation of the monomer and solvent phase. Over time, the size of these fluctuations become larger.

During a PIPS process, a porous morphology forms by kinetically arresting this decomposition with the polymerization. With increased temperature, the polymerization reaction kinetics are increased, such that the decomposition is arrested sooner in the process, resulting in smaller pores. A lower temperature delays the arresting of spinodal decomposition. Since the size of fluctuations increases with time, the arrested morphology typical has larger pores.

In one or more examples, the mixture containing the polymer precursor composition and the porogen can be heated, cooled, or otherwise maintained at a temperature of about −50° C., about −35° C., about −25° C., about −20° C., about −10° C., about −5° C., about 0° C., about 10° C., about 20° C., about 23° C., or about 25° C. to about 30° C., about 40° C., about 50° C., about 65° C., about 80° C., about 95° C., about 100° C., about 110° C., about 120° C., about 130° C., about 140° C., or about 150° C. For example, the mixture containing the polymer precursor composition and the porogen can be heated, cooled, or otherwise maintained at a temperature of about −50° C. to about 150° C., about −50° C. to about 120° C., about −50° C. to about 100° C., about −50° C. to about 80° C., about −50° C. to about 60° C., about −50° C. to about 50° C., about −50° C. to about 35° C., about −50° C. to about 25° C., about −50° C. to about 20° C., about −50° C. to about 0° C., about 0° C. to about 150° C., about 0° C. to about 120° C., about 0° C. to about 100° C., about 0° C. to about 80° C., about 0° C. to about 60° C., about 0° C. to about 50° C., about 0° C. to about 35° C., about 0° C. to about 25° C., about 0° C. to about 20° C., about 0° C. to about 10° C., about 23° C. to about 150° C., about 23° C. to about 120° C., about 23° C. to about 100° C., about 23° C. to about 80° C., about 23° C. to about 60° C., about 23° C. to about 50° C., about 23° C. to about 35° C., or about 23° C. to about 25° C. In some examples, the mixture containing the polymer precursor composition and the porogen can be maintained at ambient temperature or room temperature, such as about 20° C., about 23° C., or about 25° C.

In one or more embodiments, the porogen can be any material which can assist in forming pores in the polymeric material during the polymerization process. The porogen can be a material in a solid state or a liquid state when introduced into the mixture containing the polymer precursor composition. In one or more examples, the porogen contains one or more organic carbonates. For example, the porogen can be or include ethylene carbonate (EC), dimethyl carbonate (DMC), propylene carbonate (PC), vinylene carbonate, diethyl carbonate, fluoroethylene carbonate (FEC), derivatives thereof, or any combination thereof. In other examples, the porogen can be a solvent which is miscible with monomer used to produce the polymeric material, but immiscible with the produced polymeric material. For example, N-methyl-2-pyrrolidone (NMP) or another organic solvent is compatible with and can be included in non-aqueous (e.g., organic) processing of battery electrodes. In other examples, water is compatible with and can be included in aqueous processing of battery electrodes or aqueous electrolytes.

The polymer precursor composition can include one or more monomers, one or more prepolymers, one or more cross-linkers, one or more densifiers, one or more initiators, one or more curing agents, one or more additives, one or more solvents, or any combination thereof. In one or more embodiments, the polymer precursor composition contains one, two, or more monomers selected from acrylates, methacrylates, alkenes, alkynes, styrenes, vinyl ethers, epoxides, urethanes, monomers thereof, derivatives thereof, or any combination thereof. In some examples, the polymer precursor composition contains one or more of 1,3-propanediol diacrylate, 1,4-butanediol diacrylate (BDDA), 1,5-pentanediol diacrylate, 1,6-hexanediol diacrylate, ethylene diacrylate, trimethylolpropane triacrylate, pentaerythritol tetraacrylate, methyl methacrylate, glycidyl methacrylate, vinyl pyridine, N-vinylpyrrolidone, acrylonitrile, derivatives thereof, or combinations thereof.

In one or more embodiments, the polymer precursor composition contains one or more crosslinkers. The crosslinker can be or include one or more acrylates, one or more methacrylates, one or more alkenes or vinyls, or any combination thereof. An acrylate can be or include a diacrylate, a triacrylate, a tetraacrylate, or other multi-acrylates. Exemplary crosslinkers can be or include trimethylolpropane triacrylate (TMPTA), pentaerythritol tetraacrylate (PETA), 1,4 butanediol diacrylate (BDDA), 1,6 hexanediol diacrylate, tripropylene glycol diacrylate, dipropylene glycol diacrylate, urethane dimethacrylate, or any combination thereof. Other crosslinkers can be or include multi-functional thiols, multi-functional epoxides, or combinations thereof. The crosslinker can be included in the polymer precursor composition in an amount of about 1 wt %, about 3 wt %, or about 5 wt % to about 7 wt %, about 10 wt %, about 15 wt %, about 20 wt %, about 30 wt %, or greater, based on the weight of the primary monomer.

In one or more examples, the polymeric film or the polymeric material is formed or otherwise produced from about 100 wt % of BDDA. In some examples, the polymeric film or the polymeric material is formed or otherwise produced from about 85 wt % to about 99 wt % of BDDA and about 1 wt % to about 15 wt % of TMPTA. In other examples, the polymeric film or the polymeric material is formed or otherwise produced from about 88 wt % to about 97 wt % of BDDA and about 3 wt % to about 12 wt % of TMPTA. In some examples, the polymeric film or the polymeric material is formed or otherwise produced from about 90 wt % to about 95 wt % of BDDA and about 5 wt % to about 10 wt % of TMPTA. In other examples, the polymeric film or the polymeric material is formed or otherwise produced from about 92 wt % to about 94 wt % of BDDA and about 6 wt % to about 8 wt % of TMPTA.

The polymeric film containing the polymeric material and the porogen has about 30 wt %, about 35 wt %, about 40 wt %, about 45 wt %, about 50 wt %, or about 55 wt % to about 60 wt %, about 65 wt %, about 70 wt %, about 75 wt %, about 80 wt %, about 85 wt % or more of the polymeric material, based on the combined weight of the polymeric material and the porogen. For example, the polymeric film containing the polymeric material and the porogen has about 30 wt % to about 85 wt %, about 30 wt % to about 80 wt %, about 30 wt % to about 75 wt %, about 30 wt % to about 70 wt %, about 30 wt % to about 60 wt %, about 30 wt % to about 50 wt %, about 30 wt % to about 40 wt %, about 30 wt % to about 35 wt %, about 40 wt % to about 85 wt %, about 40 wt % to about 80 wt %, about 40 wt % to about 75 wt %, about 40 wt % to about 70 wt %, about 40 wt % to about 60 wt %, about 40 wt % to about 50 wt %, about 40 wt % to about 45 wt %, about 50 wt % to about 85 wt %, about 50 wt % to about 80 wt %, about 50 wt % to about 75 wt %, about 50 wt % to about 70 wt %, about 50 wt % to about 60 wt %, or about 50 wt % to about 55 wt % of the polymeric material, based on the combined weight of the polymeric material and the porogen.

The polymeric film containing the polymeric material and the porogen has about 20 wt %, about 25 wt %, about 30 wt %, about 35 wt %, about 40 wt %, or about 45 wt % to about 50 wt %, about 55 wt %, about 60 wt %, about 65 wt %, about 70 wt %, about 75 wt % or more of the porogen, based on the combined weight of the polymeric material and the porogen. For example, the polymeric film containing the polymeric material and the porogen has about 20 wt % to about 75 wt %, about 20 wt % to about 70 wt %, about 20 wt % to about 60 wt %, about 20 wt % to about 50 wt %, about 20 wt % to about 40 wt %, about 20 wt % to about 30 wt %, about 30 wt % to about 75 wt %, about 30 wt % to about 70 wt %, about 30 wt % to about 60 wt %, about 30 wt % to about 50 wt %, about 30 wt % to about 40 wt %, about 40 wt % to about 75 wt %, about 40 wt % to about 70 wt %, about 40 wt % to about 60 wt %, or about 40 wt % to about 50 wt % of the porogen, based on the combined weight of the polymeric material and the porogen.

In other embodiments, the polymeric material of the polymeric film is produced as a co-polymer which has specified functionality due to corresponding functional groups added to the polymeric material. In some examples, a co-monomer containing one or more Lewis-base functional groups can be incorporated into the polymeric material. The Lewis-base functional groups can be used to trap or otherwise neutralize free acid within the electrolyte. A common mode of degradation of lithium ion batteries and electrochemical cells is the formation of hydrogen fluoride (HF) derived from the electrolyte. The free HF can damage the electrochemical cells and reduce charge capacity. However, a porous separator with Lewis-base functional groups incorporated into the polymeric material can scavenge the free acid, such as hydrogen fluoride, from the electrolyte.

In one or more embodiments, the polymer precursor composition contains one or more primary monomers, one or more co-monomers, one or more prepolymers, or any combination thereof. In one or more examples, the co-monomer contains one or more Lewis-base functional groups. Exemplary functionalized co-monomers can be or include one or more amines, one or more pyridines, one or more nitriles, one or more phosphines, one or more carboxylates, one or more borates, complexes thereof, derivatives thereof, or any combination thereof. The co-monomer can be included in the polymer precursor composition in an amount of about 20 wt %, about 30 wt %, or about 40 wt % to about 50 wt %, about 60 wt %, about 70 wt %, or greater, based on the weight of the primary monomer. In some examples, the co-monomer can be or include 2-(dimethylamino)ethyl acrylate (DMEA) as a monomer with a Lewis-base functional group.

In one or more examples, the polymeric film or the polymeric material is formed or otherwise produced from about 10 wt % to about 50 wt % of DMEA and about 50 wt % to about 90 wt % of BDDA. In other examples, the polymeric film or the polymeric material is formed or otherwise produced from about 15 wt % to about 35 wt % of DMEA, about 50 wt % to about 80 wt % of BDDA, and about 3 wt % to about 12 wt % of TMPTA. In some examples, the polymeric film or the polymeric material is formed or otherwise produced from about 20 wt % to about 30 wt % of DMEA, about 60 wt % to about 75 wt % of BDDA, and about 5 wt % to about 10 wt % of TMPTA. In other examples, the polymeric film or the polymeric material is formed or otherwise produced from about 23 wt % to about 27 wt % of DMEA, about 65 wt % to about 70 wt % of BDDA, and about 6 wt % to about 8 wt % of TMPTA.

In some examples, the polymer precursor composition contains one or more initiators or curing agents. For example, a UV-curing agent can be used to initiate the photo polymerization of chemically unsaturated bonds within the polymer precursor composition. The initiator or curing agent can be included in the polymer precursor composition in an amount of about 0.01 wt %, about 0.1 wt %, or about 0.5 wt % to about 0.7 wt %, about 1 wt %, about 1.2 wt %, or about 2 wt %, based on the weight of the primary monomer. An exemplary initiator or curing agent which can be used to initiate the polymerization reaction is 2-benzyl-2-(dimethylamino)-4, commercially available as Omnirad 369 agent. In one or more examples, an initiator is introduced or otherwise added into the mixture prior to exposing the mixture to the ultraviolet radiation. Thereafter, the mixture containing the polymer precursor composition and the porogen can be exposed to ultraviolet radiation to form the polymeric film on one or more surfaces (e.g., electrode or reaction cell) during the polymerization process.

In one or more embodiments, the polymeric film is formed or otherwise produced on an electrode, such as a cathode and/or anode, that is used within an electrochemical cell or battery. The polymeric film is produced from the mixture containing the polymer precursor composition and the porogen. In some examples, the porogen contains or is ethylene carbonate and the electrolyte contains or is at least chemically compatible with ethylene carbonate. As such, the porogen can be maintained in the polymeric material when placed within in electrochemical cell. At least a portion of the porogen, or all of the porogen, is dissolved by the electrolyte within the electrochemical cell to reveal the plurality of pores within the polymeric material.

In other embodiments, the polymeric film is formed or otherwise produced on a surface within a reaction chamber. The polymeric film is produced from the mixture containing the polymer precursor composition and the porogen. The porogen can be removed from the polymeric material by soaking, rinsing, or otherwise exposing the porogen to one or more solvents. For example, the polymeric material containing the porogen within the pores can be exposed to a solvent which dissolves and removes at least a portion of the porogen, or all of the porogen, from the polymeric material to produce and/or reveal the plurality of pores within the polymeric material. Exemplary solvents can be or include acetone, methyl ethyl ketone (MEK), diethyl ether, tetrahydrofuran (THF), one or more alcohols, or combinations thereof.

Each of the porous separator, the polymeric film, or the polymeric material can independently have a thickness of about 0.5 μm, about 1 μm, about 2 μm, about 5 μm, about 8 μm, about 10 μm, about 12 μm, about 15 μm, about 18 μm, or about 20 μm to about 22 μm, about 25 μm, about 28 μm, about 30 μm, about 35 μm, about 40 μm, about 50 μm, about 60 μm, about 80 μm, about 95 μm, about 100 μm, about 120 μm, about 150 μm, about 180 μm, or about 200 μm. For example, each of the porous separator, the polymeric film, or the polymeric material can independently have a thickness of about 1 μm to about 200 μm, about 1 μm to about 150 μm, about 1 μm to about 100 μm, about 1 μm to about 80 μm, about 1 μm to about 50 μm, about 1 μm to about 40 μm, about 1 μm to about 30 μm, about 1 μm to about 25 μm, about 1 μm to about 20 μm, about 1 μm to about 15 μm, about 1 μm to about 10 μm, about 1 μm to about 5 μm, about 5 μm to about 200 μm, about 5 μm to about 150 μm, about 5 μm to about 100 μm, about 5 μm to about 80 μm, about 5 μm to about 50 μm, about 5 μm to about 40 μm, about 5 μm to about 30 μm, about 5 μm to about 25 μm, about 5 μm to about 20 μm, about 5 μm to about 15 μm, about 5 μm to about 10 μm, about 10 μm to about 200 μm, about 10 μm to about 150 μm, about 10 μm to about 100 μm, about 10 μm to about 80 μm, about 10 μm to about 50 μm, about 10 μm to about 40 μm, about 10 μm to about 30 μm, about 10 μm to about 25 μm, about 10 μm to about 20 μm, about 10 μm to about 15 μm, about 15 μm to about 100 μm, about 15 μm to about 80 μm, about 15 μm to about 50 μm, about 15 μm to about 30 μm, about 20 μm to about 200 μm, about 20 μm to about 150 μm, about 20 μm to about 100 μm, about 20 μm to about 80 μm, about 20 μm to about 50 μm, about 20 μm to about 40 μm, about 20 μm to about 30 μm, or about 20 μm to about 25 μm.

Each of the porous separator, the polymeric film, or the polymeric material can independently have a porosity of about 10%, about 15%, about 20%, about 25%, or about 30% to about 35%, about 40%, about 45%, about 50%, about 55%, about 60%, or greater. For example, each of the porous separator, the polymeric film, or the polymeric material can independently have a porosity of about 10% to about 60%, about 10% to about 50%, about 10% to about 45%, about 10% to about 40%, about 10% to about 35%, about 10% to about 30%, about 10% to about 25%, about 10% to about 20%, about 20% to about 60%, about 20% to about 50%, about 20% to about 45%, about 20% to about 40%, about 20% to about 35%, about 20% to about 30%, about 20% to about 25%, about 20% to about 20%, about 25% to about 60%, about 25% to about 50%, about 25% to about 45%, about 25% to about 40%, about 25% to about 35%, or about 25% to about 30%. The porosity values can be calculated by mercury porosimetry, as well as other known techniques.

The porous separator absorbs or otherwise contains an electrolyte within the pores of the polymeric material. The electrolyte uptake is based on the weight of the electrolyte contained in the porous separator relative to the weight of the dry porous separator without the electrolyte (e.g., the polymeric material). In one or more embodiments, the porous separator has an electrolyte uptake of about 40 wt %, about 50 wt %, about 60 wt %, about 67 wt %, about 70 wt %, or about 75 wt % to about 80 wt %, about 90 wt %, about 100 wt %, about 120 wt %, about 127 wt %, about 135 wt %, about 150 wt %, about 170 wt %, about 185 wt %, about 200 wt %, about 250 wt %, or greater. For example, the porous separator has an electrolyte uptake of about 40 wt % to about 200 wt %, about 40 wt % to about 175 wt %, about 40 wt % to about 150 wt %, about 40 wt % to about 135 wt %, about 40 wt % to about 120 wt %, about 40 wt % to about 100 wt %, about 40 wt % to about 80 wt %, about 40 wt % to about 65 wt %, about 50 wt % to about 200 wt %, about 50 wt % to about 175 wt %, about 50 wt % to about 150 wt %, about 50 wt % to about 135 wt %, about 50 wt % to about 120 wt %, about 50 wt % to about 100 wt %, about 50 wt % to about 80 wt %, about 50 wt % to about 65 wt %, about 75 wt % to about 200 wt %, about 75 wt % to about 175 wt %, about 75 wt % to about 150 wt %, about 75 wt % to about 135 wt %, about 75 wt % to about 120 wt %, about 75 wt % to about 100 wt %, or about 75 wt % to about 90 wt %.

In one or more examples, the porous separator can be prepared by placing a mixture containing the polymer precursor composition and the porogen containing ethylene carbonate onto one or more surfaces and forming the polymeric film on the surface by a polymerization-induced phase separation (PIPS) process. The polymeric film contains pores formed during the PIPS process. The porogen is disposed within the pores distributed throughout the polymeric film. The polymeric film contains about 20 wt % to about 70 wt % of the porogen.

In other examples, a porous separator is provided and includes the polymeric film containing pores distributed throughout a polymeric material, where the polymeric film has a porosity of about 10% to about 50% and a thickness of about 1 μm to about 200 μm. The porous separator also includes a porogen disposed within the pores, where the porogen contains ethylene carbonate (EC), dimethyl carbonate (DMC), propylene carbonate (PC), vinylene carbonate, diethyl carbonate, fluoroethylene carbonate (FEC), derivatives thereof, or any combination thereof.

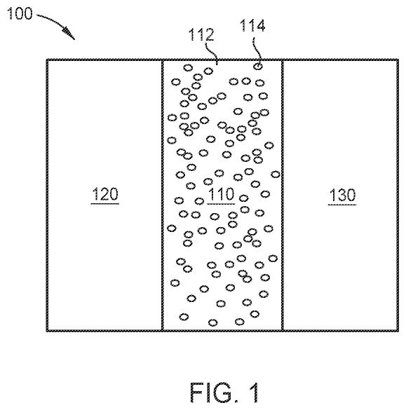

FIG. 1 depicts a cross-sectional view of an electrochemical cell 100 containing a porous separator 110, as described and discussed in one or more embodiments herein. The electrochemical cell 100 includes a cathode 120 separated by an anode 130 by the porous separator 110. The porous separator 110 is or includes one or more polymeric films prepared by processes described and discussed herein. Each of the polymeric films contains a plurality of pores 114 distributed throughout a polymeric material 112. The porous separator 110 can be or include any porous separator described and discussed herein. The electrochemical cell 100 also includes one or more electrolytes (not shown). The electrolyte impregnates the porous separator 110 and is located throughout the electrochemical cell 100 including within the pores 114 and in contact with the polymeric material 112, the cathode 120, and the anode 130.

In one or more examples, the electrochemical cell 100 can be a single cell battery. In other examples, a plurality of electrochemical cells 100 can be coupled together to produce a multi-cell battery. The electrochemical cell 100 can be many different types of cells, such as a lithium ion cell, a lithium metal cell, a lithium-sulfur cell, a sodium ion cell, a magnesium ion cell, a calcium ion cell, an aluminum ion cell, a nickel ion cell, a lead acid cell, and other types of cells and/or batteries. The electrochemical cell 100 can be composed of a variety of different materials and components based on the desired type of cell or battery. For example, the polymeric material 112, the cathode 120, the anode 130, and the electrolyte may contain a variety of different materials depending on the type of battery.

The cathode 120 can be or include one or more cathodic materials.

Exemplary cathodic materials can be or include one or more of NMC (or NCM)—lithium nickel cobalt manganese oxide (LiNiₓMo_{y}Co_{(1-x-y)}O₂, where x=about 0.3333 to about 0.9 and y=about 0.05 to about 0.3), NCA—lithium nickel cobalt aluminum oxide (LiNiCoAlO₂), LMO—lithium manganese oxide (LiMn₂O₄), LNMO—lithium nickel manganese spinel (LiNi_{0.5}Mn_{1.5}O₄), LCO—lithium cobalt oxide (LiCoO₂), LFP—lithium iron phosphate (LiFePO₄/C), LTO—lithium titanate oxide (e.g., Li₄Ti₅O₁₂, Li[Li_{0.33}Ti_{1.67}]O₄, or 2Li₂O·5TiO₂), sulfur, alloys thereof, oxides thereof, dopants thereof, or any combination thereof. In some examples, the lithium nickel cobalt manganese oxide cathode can be or include NMC-333 (x=0.333 and y=0.333), NMC-532 (x=0.5 and y=0.3), NMC-622 (x=0.6 and y=0.2), NMC-811 (x=0.8 and y=0.1), and NMC-955 (x=0.9 and y=0.05). The anode 130 can be or include one or more anodic materials. Exemplary anodic materials can be or include one or more of graphite (including natural and/or synthetic), carbon black, activated carbon, graphene, LTO (lithium titanate oxide), silicon, surface-functionalized silicon, metallic lithium, dopants thereof, or any combination thereof. Synthetic graphite is typically mined and/or ground from a natural source, while synthetic or artificial graphite is generally prepared in a reactor or other vessel.

The electrolyte can include one or more salts, one or more solvents, or any combination thereof. In one or more examples, the electrolyte for a lithium ion battery contains one or more lithium salts and one or more solvents. For example, the salt within the electrolyte can be or include lithium hexafluorophosphate (LiPF₆), lithium hexafluoroarsenate (LiAsF₆), lithium tetrafluoroborate (LiBF₄), lithium perchlorate (LiClO₄), lithium bis(trifluoromethanesulfonyl)imide (LiTFSI), lithium bis(fluorosulfonyl)imide (LiFSI), or any combination thereof. The solvent within the electrolyte can be or include one or more organic carbonates, one or more ethers, one or more aqueous solutions, or combinations thereof. Exemplary solvent within the electrolyte can be or include one or more of ethylene carbonate, dimethyl carbonate, diethyl carbonate, propylene carbonate, ethyl methyl carbonate, dioxane, dimethoxyethane, water, aqueous electrolyte, or any combination thereof. Other electrolytes can be used in electrochemical cell 100.

In one or more embodiments, the electrochemical cell 100, utilizing the porous separator 110 fabricated by the methods discussed and described herein, has a coulombic efficiency of about 99%, about 99.5%, about 99.9%, or about 99.95% to about 99.99%, about 99.995%, about 99.999%, about 99.99995%, or greater over 100 charge/discharge cycles of the electrochemical cell.

### Examples

In order to provide a better understanding of the foregoing discussion, the following non-limiting examples are offered. Although the examples can be directed to specific embodiments, they are not to be viewed as limiting embodiments of the invention in any specific respect.

It has been surprisingly and unexpectedly discovered that by following the methods discussed and described herein, porous separators with exceptional performance properties can be prepared. These porous separators have high values of porosity and electrolyte uptake while being strong polymeric films which have a relatively minimal thickness (e.g., about 10 μm to about 30 μm) and long life expectancy in an environment of electrolyte.

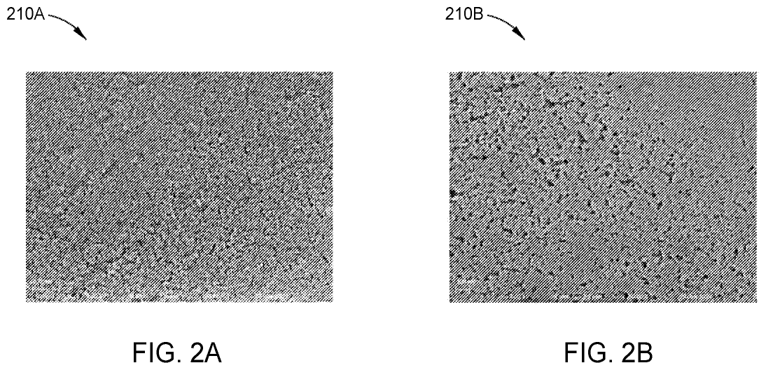

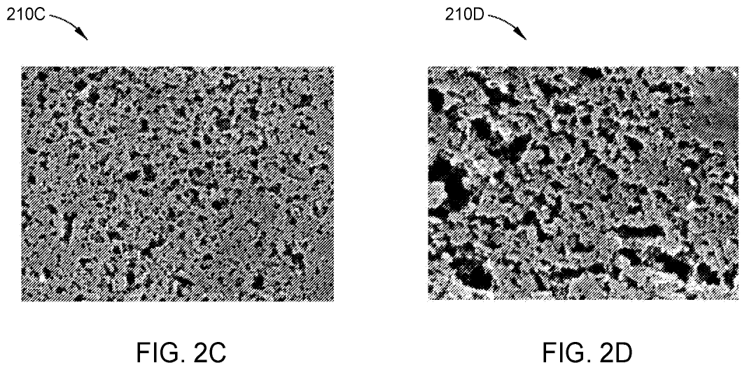

FIGS. 2A-2D are scanning electron microscope (SEM) images of porous separators 210A-210D, respectively, as described and discussed in one or more embodiments herein. The porous separators 210A-210D were formed from the same polymeric material, but with varying concentrations of the porogen. The polymeric material contained poly(1,4-butanediol diacrylate) (pBDDA) and the porogen contained ethylene carbonate (EC). An initiator, Omnirad 369 agent, was also included in the polymeric mixture which contained the monomer 1,4-butanediol diacrylate. The porous separator 210A contained about 30 wt % of the porogen and about 70 wt % of the polymeric material, the porous separator 210B contained about 40 wt % of the porogen and about 60 wt % of the polymeric material, the porous separator 210C contained about 50 wt % of the porogen and about 50 wt % of the polymeric material, and the porous separator 210D contained about 60 wt % of the porogen and about 40 wt % of the polymeric material.

Each of the porous separators 210A-210D was formed in a reaction cell between two slides separated by one or more spacers. The polymeric mixture was placed into the reaction cell between the slides and irradiated with ultraviolet radiation to initiated the polymeric reaction. The polymeric mixture was converted to a polymeric film containing the porogen dispersed throughout the polymeric material. Once removed from the reaction cell, the polymeric film was rinsed with acetone to remove the porogen, or at least a portion of the porogen, from the pores within the polymeric material. Each of the porous separators 210A-210D had varying amount of pores proportionally based on the varying amount of porogen used to form the polymeric film, as depicted in FIGS. 2A-2D. The porous separators 210A-210D were measured for porosity and electrolyte uptake (based on the weight of an electrolyte relative to the weight of the dry porous separator). The porous separator 210A had a porosity of about 15.4% and an electrolyte uptake of about 45 wt %, the porous separator 210B had a porosity of about 17.0% and an electrolyte uptake of about 50 wt %, the porous separator 210C had a porosity of about 30.4% and an electrolyte uptake of about 67 wt %, and the porous separator 210D had a porosity of about 38.5% and an electrolyte uptake of about 127 wt %.

Electrochemical cells containing the porous separators made by the methods discussed and described herein were found to have the same or better values for discharge capacity over cycle index, as well as values for voltage over discharge capacity for at least 100 cycles, as compared to similar electrochemical cells containing commercial separators made from polyolefins (e.g., Celgard 2500 separators).

Embodiments of the present disclosure further relate to any one or more of the following examples 1-44:

1. A method of preparing a porous separator for an electrochemical cell, comprising: placing a mixture comprising a polymer precursor composition and a porogen onto a surface; and forming a polymeric film on the surface from the mixture by a polymerization process, wherein the polymeric film comprises pores distributed throughout a polymeric material, wherein the pores are formed during the polymerization process, and wherein the porogen is disposed within the pores.

2. A method of preparing a porous separator for an electrochemical cell, comprising: placing a mixture comprising a polymer precursor composition and a porogen comprising ethylene carbonate onto a surface; and forming a polymeric film on the surface from the mixture by a polymerization-induced phase separation (PIPS) process, wherein the polymeric film comprises pores formed during the PIPS process, wherein the porogen is disposed within the pores distributed throughout the polymeric film, and wherein the polymeric film contains about 20 wt % to about 70 wt % of the porogen.

3. A method of preparing a separator for an electrochemical cell, comprising: placing a mixture comprising a polymer precursor composition and a porogen onto a surface; and forming a polymeric film on the surface from the mixture by a polymerization process, wherein the porogen is disposed throughout the polymeric film.

4. The method according to any one of examples 1-3, wherein at least a portion of the porogen is dissolved by an electrolyte within the electrochemical cell.

5. The method according to any one of examples 1-4, wherein at least a portion of the porogen is removed from the polymeric film by exposing the porogen to a solvent prior to positioning the polymeric film into the electrochemical cell.

6. The method according to any one of examples 1-5, wherein the polymeric film contains about 20 wt % to about 70 wt % of the porogen, based on the combined weight of the polymeric material and the porogen.

7. The method according to any one of examples 1-6, wherein the polymerization process is selected from a polymerization-induced phase separation (PIPS) process, a polymerization-induced microphase separation (PIMS) process, a photo-induced phase separation process, or a reaction-induced phase separation process.

8. The method according to any one of examples 1-7, wherein the polymer precursor composition comprises an acrylate, a methacrylate, an alkene, an alkyne, a styrene, a vinyl ether, an epoxide, an urethane, monomers thereof, derivatives thereof, or any combination thereof.

9. The method according to any one of examples 1-8, wherein the polymer precursor composition comprises 1,3-propanediol diacrylate, 1,4-butanediol diacrylate (BDDA), 1,5-pentanediol diacrylate, 1,6-hexanediol diacrylate, ethylene diacrylate, trimethylolpropane triacrylate, pentaerythritol tetraacrylate, methyl methacrylate, glycidyl methacrylate, vinyl pyridine, N-vinylpyrrolidone, acrylonitrile, or combinations thereof.

10. The method according to any one of examples 1-9, wherein the porogen comprises an organic carbonate.

11. The method according to any one of examples 1-10, wherein the porogen comprises ethylene carbonate (EC), dimethyl carbonate (DMC), propylene carbonate (PC), vinylene carbonate, diethyl carbonate, fluoroethylene carbonate (FEC), derivatives thereof, or any combination thereof.

12. The method according to any one of examples 1-11, wherein the polymeric film has a thickness of about 1 μm to about 200 μm.

13. The method according to any one of examples 1-12, wherein the polymeric film has a porosity of about 10% to about 50%.

14. The method according to any one of examples 1-13, wherein the polymer precursor composition comprises one or more primary monomers, one or more co-monomers, one or more prepolymers, or any combination thereof.

15. The method according to any one of examples 1-14, wherein the co-monomer comprises one or more Lewis-base functional groups.

16. The method according to any one of examples 1-15, wherein the co-monomer comprises an amine, a pyridine, a nitrile, a phosphine, a carboxylate, a borate, complexes thereof, derivatives thereof, or any combination thereof.

17. The method according to any one of examples 1-16, wherein the polymer precursor composition comprises a crosslinker.

18. The method according to any one of examples 1-17, wherein the crosslinker comprises an acrylate, a methacrylate, an alkene or vinyl, or any combination thereof.

19. The method according to any one of examples 1-18, wherein the crosslinker comprises trimethylolpropane triacrylate (TMPTA), pentaerythritol tetraacrylate (PETA), 1,4 butanediol diacrylate (BDDA), 1,6 hexanediol diacrylate, tripropylene glycol diacrylate, dipropylene glycol diacrylate, urethane dimethacrylate, or any combination thereof.

20. The method according to any one of examples 1-19, wherein the polymeric film is formed on the surface of an electrode of the electrochemical cell.

21. The method according to any one of examples 1-20, further comprising exposing the mixture comprising the polymer precursor composition and the porogen to ultraviolet radiation to form the polymeric film on the surface during the polymerization process.

22. The method according to any one of examples 1-21, further comprising introducing an initiator into the mixture prior to exposing the mixture to the ultraviolet radiation.

23. The method according to any one of examples 1-22, further comprising removing the porogen from the polymeric film to produce and/or reveal pores throughout the polymeric film.

24. A battery comprising the porous separator prepared by the method according to any one of examples 1-23.

25. The battery according to example 24, wherein the electrochemical cell has a coulombic efficiency of about 99.9% to about 99.999% over 100 charge/discharge cycles of the electrochemical cell.

26. The battery according to example 23 or 24, wherein the porous separator comprises an electrolyte uptake of about 40 wt % to about 200 wt % of an electrolyte.

27. The battery according to any one of examples 24-26, wherein the electrochemical cell has an electrolyte comprising a salt selected from lithium hexafluorophosphate (LiPF₆), lithium hexafluoroarsenate (LiAsF₆), lithium tetrafluoroborate (LiBF₄), lithium perchlorate (LiClO₄), lithium bis(trifluoromethanesulfonyl)imide (LiTFSI), lithium bis(fluorosulfonyl)imide (LiFSI), or any combination thereof.

28. A porous separator, comprising: a polymeric film comprising pores distributed throughout a polymeric material, wherein the polymeric film has a porosity of about 10% to about 50%, and wherein the polymeric film has a thickness of about 1 μm to about 200 μm; and a porogen disposed within the pores, wherein the porogen comprises ethylene carbonate (EC), dimethyl carbonate (DMC), propylene carbonate (PC), vinylene carbonate, diethyl carbonate, fluoroethylene carbonate (FEC), derivatives thereof, or any combination thereof.

29. The porous separator according to example 28, wherein the polymeric material and the pores are prepared by a polymerization process selected from a polymerization-induced phase separation (PIPS) process, a polymerization-induced microphase separation (PIMS) process, a photo-induced phase separation process, or a reaction-induced phase separation process.

30. The porous separator according to example 28 or 29, wherein the polymeric material is prepared from a polymer precursor composition comprising an acrylate, a methacrylate, an alkene, an alkyne, a styrene, a vinyl ether, an epoxide, an urethane, monomers thereof, derivatives thereof, or any combination thereof.

31. The porous separator according to any one of examples 28-30, wherein the polymeric material is prepared from a polymer precursor composition comprising 1,3-propanediol diacrylate, 1,4-butanediol diacrylate (BDDA), 1,5-pentanediol diacrylate, 1,6-hexanediol diacrylate, ethylene diacrylate, trimethylolpropane triacrylate, pentaerythritol tetraacrylate, methyl methacrylate, glycidyl methacrylate, vinyl pyridine, N-vinylpyrrolidone, acrylonitrile, or combinations thereof.

32. The porous separator according to any one of examples 28-31, wherein the polymeric film has a thickness of about 10 μm to about 80 μm.

33. The porous separator according to any one of examples 28-32, wherein the polymeric film contains about 30 wt % to about 60 wt % of the porogen, based on the combined weight of the polymeric material and the porogen.

34. The porous separator according to any one of examples 28-33, wherein the polymeric film has a porosity of about 10% to about 50%.

35. The porous separator according to any one of examples 28-34, wherein the polymer precursor composition comprises one or more primary monomers, one or more co-monomers, one or more prepolymers, or any combination thereof.

36. The porous separator according to any one of examples 28-35, wherein the co-monomer comprises one or more Lewis-base functional groups.

37. The porous separator according to any one of examples 28-36, wherein the co-monomer comprises an amine, a pyridine, a nitrile, a phosphine, a carboxylate, a borate, complexes thereof, derivatives thereof, or any combination thereof.

38. The porous separator according to any one of examples 28-37, wherein the polymer precursor composition comprises a crosslinker.

39. The porous separator according to any one of examples 28-38, wherein the crosslinker comprises an acrylate, a methacrylate, an alkene or vinyl, or any combination thereof.

40. The porous separator according to any one of examples 28-39, wherein the crosslinker comprises trimethylolpropane triacrylate (TMPTA), pentaerythritol tetraacrylate (PETA), 1,4 butanediol diacrylate (BDDA), 1,6 hexanediol diacrylate, tripropylene glycol diacrylate, dipropylene glycol diacrylate, urethane dimethacrylate, or any combination thereof.

41. A battery comprising the porous separator according to any one of examples 28-40.

42. The battery according to example 41, wherein the electrochemical cell has a coulombic efficiency of about 99.9% to about 99.999% over 100 charge/discharge cycles of the electrochemical cell.

43. The battery according to example 41 or 42, wherein the porous separator comprises an electrolyte uptake of about 40 wt % to about 200 wt % of an electrolyte.

44. The battery according to any one of examples 41-43, wherein the electrochemical cell comprises an electrolyte selected from lithium hexafluorophosphate (LiPF₆), lithium hexafluoroarsenate (LiAsF₆), lithium tetrafluoroborate (LiBF₄), lithium perchlorate (LiClO₄), lithium bis(trifluoromethanesulfonyl)imide (LiTFSI), lithium bis(fluorosulfonyl)imide (LiFSI), or any combination thereof.

While the foregoing is directed to embodiments of the disclosure, other and further embodiments may be devised without departing from the basic scope thereof, and the scope thereof is determined by the claims that follow. All documents described herein are incorporated by reference herein, including any priority documents and/or testing procedures to the extent they are not inconsistent with this text. As is apparent from the foregoing general description and the specific embodiments, while forms of the present disclosure have been illustrated and described, various modifications can be made without departing from the spirit and scope of the present disclosure. Accordingly, it is not intended that the present disclosure be limited thereby. Likewise, the term “comprising” is considered synonymous with the term “including” for purposes of United States law. Likewise, whenever a composition, an element, or a group of elements is preceded with the transitional phrase “comprising”, it is understood that the same composition or group of elements with transitional phrases “consisting essentially of”, “consisting of”, “selected from the group of consisting of”, or “is” preceding the recitation of the composition, element, or elements and vice versa, are contemplated. As used herein, the term “about” refers to a +/−10% variation from the nominal value. It is to be understood that such a variation can be included in any value provided herein.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below.

1-44. (canceled)

45. A method of preparing a porous separator for an electrochemical cell, comprising:
placing a mixture comprising a polymer precursor composition and a porogen onto a surface; and
forming a polymeric film on the surface from the mixture by a polymerization process, wherein the polymeric film comprises pores distributed throughout a polymeric material, wherein the pores are formed during the polymerization process, and wherein the porogen is disposed within the pores.

46. The method of claim 45, wherein at least a portion of the porogen is dissolved by an electrolyte within the electrochemical cell.

47. The method of claim 45, wherein at least a portion of the porogen is removed from the polymeric film by exposing the porogen to a solvent prior to positioning the polymeric film into the electrochemical cell.

48. The method of claim 45, wherein the polymeric film contains about 20 wt % to about 70 wt % of the porogen, based on the combined weight of the polymeric material and the porogen.

49. The method of claim 45, wherein the polymerization process is selected from a polymerization-induced phase separation (PIPS) process, a polymerization-induced microphase separation (PIMS) process, a photo-induced phase separation process, or a reaction-induced phase separation process.

50. The method of claim 45, wherein the polymer precursor composition comprises 1,3-propanediol diacrylate, 1,4-butanediol diacrylate (BDDA), 1,5-pentanediol diacrylate, 1,6-hexanediol diacrylate, ethylene diacrylate, trimethylolpropane triacrylate, pentaerythritol tetraacrylate, methyl methacrylate, glycidyl methacrylate, vinyl pyridine, N-vinylpyrrolidone, acrylonitrile, or combinations thereof.

51. The method of claim 45, wherein the porogen comprises ethylene carbonate (EC), dimethyl carbonate (DMC), propylene carbonate (PC), vinylene carbonate, diethyl carbonate, fluoroethylene carbonate (FEC), derivatives thereof, or any combination thereof.

52. The method of claim 45, wherein the polymeric film has a thickness of about 1 μm to about 200 μm and a porosity of about 10% to about 50%.

53. The method of claim 45, wherein the polymer precursor composition comprises one or more co-monomers, and wherein the co-monomer comprises an amine, a pyridine, a nitrile, a phosphine, a carboxylate, a borate, complexes thereof, derivatives thereof, or any combination thereof.

54. The method of claim 45, wherein the polymer precursor composition comprises a crosslinker, and wherein the crosslinker comprises an acrylate, a methacrylate, an alkene or vinyl, or any combination thereof.

55. The method of claim 45, wherein the polymer precursor composition comprises a crosslinker, and wherein the crosslinker comprises trimethylolpropane triacrylate (TMPTA), pentaerythritol tetraacrylate (PETA), 1,4 butanediol diacrylate (BDDA), 1,6 hexanediol diacrylate, tripropylene glycol diacrylate, dipropylene glycol diacrylate, urethane dimethacrylate, or any combination thereof.

56. The method of claim 45, further comprising:
introducing an initiator into the mixture; then
exposing the mixture comprising the polymer precursor composition and the porogen to ultraviolet radiation to form the polymeric film on the surface during the polymerization process.

57. A method of preparing a porous separator for an electrochemical cell, comprising:
placing a mixture comprising a polymer precursor composition and a porogen comprising ethylene carbonate onto a surface; and
forming a polymeric film on the surface from the mixture by a polymerization-induced phase separation (PIPS) process, wherein the polymeric film comprises pores formed during the PIPS process, wherein the porogen is disposed within the pores distributed throughout the polymeric film, and wherein the polymeric film contains about 20 wt % to about 70 wt % of the porogen.

58. A porous separator, comprising:
a polymeric film comprising pores distributed throughout a polymeric material, wherein the polymeric film has a porosity of about 10% to about 50%, and wherein the polymeric film has a thickness of about 1 μm to about 200 μm; and
a porogen disposed within the pores, wherein the porogen comprises ethylene carbonate (EC), dimethyl carbonate (DMC), propylene carbonate (PC), vinylene carbonate, diethyl carbonate, fluoroethylene carbonate (FEC), derivatives thereof, or any combination thereof.

59. The porous separator of claim 58, wherein the polymeric material and the pores are prepared by a polymerization process selected from a polymerization-induced phase separation (PIPS) process, a polymerization-induced microphase separation (PIMS) process, a photo-induced phase separation process, or a reaction-induced phase separation process.

60. The porous separator of claim 58, wherein the polymeric material is prepared from a polymer precursor composition comprising 1,3-propanediol diacrylate, 1,4-butanediol diacrylate (BDDA), 1,5-pentanediol diacrylate, 1,6-hexanediol diacrylate, ethylene diacrylate, trimethylolpropane triacrylate, pentaerythritol tetraacrylate, methyl methacrylate, glycidyl methacrylate, vinyl pyridine, N-vinylpyrrolidone, acrylonitrile, or combinations thereof.

61. The porous separator of claim 58, wherein the polymeric film has a thickness of about 10 μm to about 80 μm, has a porosity of about 10% to about 50%, and contains about 30 wt % to about 60 wt % of the porogen, based on the combined weight of the polymeric material and the porogen.

62. The porous separator of claim 58, wherein the polymer precursor composition comprises one or more co-monomers, and wherein the co-monomer comprises an amine, a pyridine, a nitrile, a phosphine, a carboxylate, a borate, complexes thereof, derivatives thereof, or any combination thereof.

63. The porous separator of claim 58, wherein the polymer precursor composition comprises a crosslinker, and wherein the crosslinker comprises an acrylate, a methacrylate, an alkene or vinyl, or any combination thereof.

64. The porous separator of claim 58, wherein the polymer precursor composition comprises a crosslinker, and wherein the crosslinker comprises trimethylolpropane triacrylate (TMPTA), pentaerythritol tetraacrylate (PETA), 1,4 butanediol diacrylate (BDDA), 1,6 hexanediol diacrylate, tripropylene glycol diacrylate, dipropylene glycol diacrylate, urethane dimethacrylate, or any combination thereof.
